(19) United States
(12) Patent Application Publication
(10) Pub. No.: US 2021/0372430 A1
(43) Pub. Date: Dec. 2, 2021

(54) CENTRIFUGAL COMPRESSOR

(71) Applicant: MITSUBISHI HEAVY INDUSTRIES, LTD., Tokyo (JP)

(72) Inventors: Yutaka FUJITA, Tokyo (JP); Kenichiro IWAKIRI, Tokyo (JP)

(21) Appl. No.: 17/245,230

(22) Filed: Apr. 30, 2021

(30) Foreign Application Priority Data
May 26, 2020 (JP) 2020-091696

(51) Int. Cl. F04D 29/42; F04D 17/10; F04D 29/22; F04D 29/08

(52) U.S. Cl. CPC F04D 29/4206; F04D 29/083; F04D 29/22; F04D 17/10

(57) ABSTRACT

A centrifugal compressor includes an impeller; a compressor cover including at least an inlet pipe portion having an intake air flow path formed for sending gas to the impeller; a movable member disposed inside the compressor cover so as to be movable along a direction of an axis of the impeller; and a movement mechanism configured to move the movable member along the direction of the axis of the impeller, the movement mechanism moving the movable member in the direction of the axis to bring the movable member and an inner wall surface of the compressor cover into contact with each other. At least one of the compressor cover and the movable member has a contact portion configured of an abradable sealing material or a high-elasticity plastic material at which the compressor cover and the movable member come into contact with each other.

### CROSS-REFERENCE TO RELATED APPLICATIONS

This application claims the benefit of priority to Japanese Patent Application Number 2020-091696 filed on May 26, 2020. The entire contents of the above-identified application are hereby incorporated by reference.

### TECHNICAL FIELD

The disclosure relates to a centrifugal compressor.

### RELATED ART

Conventionally, as a technology for improving the power of engines such as automobile engines, turbochargers (superchargers) that compress intake air to be taken in by an engine, increase the density of the intake air, and supply the intake air rich in oxygen to the engine are widely used.

A turbocharger includes, for example, a rotor shaft; a centrifugal compressor (compressor) provided at one end of the rotor shaft; and a turbine provided at the other end of the rotor shaft. The turbocharger is configured such that the energy of exhaust gas sent from the engine causes the impeller of the turbine (turbine wheel) to rotate and, along with this, causes the rotor shaft as well as the impeller of the centrifugal compressor (compressor wheel) to rotate about the axis so as to compress intake air and supply the air to the engine.

Here, in automobile engines, for example, response to accelerator operation at low speed (for example, the portion denoted by the reference sign S in FIG. 4), that is, acceleration performance, performance of producing a low-speed torque, and the like are regarded as important factors that indicate their product performance.

For this reason, for centrifugal compressors of turbochargers, there is a demand for improvement in compression performance in a zone where the intake air flow rate is small and thus improvement in air supply efficiency of compressed air into the engine. There is also a demand for widening of the operation range in terms of the movable performance/operating range R expressed by the relationship between the flow rate (CW flow rate) and pressure ratio (CW pressure ratio) of the intake air, and, in particular, expansion of the movable range on the surge line side (the portion denoted by the reference sign S) in the zone where the intake air flow rate is small.

In contrast, there are centrifugal compressors that take in air from the suction port along with the rotation of the impeller of the centrifugal compressor and that are provided with a throttling mechanism in an intake air flow path for taking in air toward the impeller of the centrifugal compressor. These centrifugal compressors perform control such that the intake air flow path area is made small by the throttling mechanism when the intake air flow rate is small. As a result, it is possible to reduce the recirculation flow of the intake air, that is, backflow of the intake air, which easily occurs at the tip side (shroud side) of the rotor blade of the impeller when the intake air flow rate is small. This makes it possible to improve efficiency in the zone where the flow rate is small and widen the operation range.

Some of this type of throttling mechanism include an annular member disposed coaxially with the intake air flow path in a fixed manner. In this throttling mechanism, the fixed annular member acts like a protective wall, enabling backflow to be reduced when the intake air flow rate is small.

However, when the intake air flow rate is medium to large, there is a risk that the choke flow rate (maximum flow rate) and the efficiency on the large flow rate side may decrease.

On the other hand, there are those configurations that include a movable member (such as an annular member) disposed coaxially with the intake air flow path of the centrifugal compressor and supported so as to be able to advance and retract forward and rearward in the direction of the axis between the suction port and the impeller of the intake air flow path; and a movement mechanism configured to move the movable member to advance and retract in the forward and rearward directions along the axis (see, for example, U.S. Pat. No. 9,777,640 (WO 2019/004228, JP 2019-152121 A)).

For example, this throttling mechanism is configured, when the intake air flow rate is medium to large, to cause the movable member to advance forward and be disposed to make the flow path area of the intake air flow path large. This throttling mechanism is configured such that, when the intake air flow rate is small, the movement mechanism causes the movable member to evacuate rearward so as to come closer to the impeller of the centrifugal compressor and the movable member abuts against and closely contacts the inner wall surface of the compressor cover that forms the intake air flow path.

As a result, neither the choke flow rate nor the efficiency on the large flow rate side decreases when the intake air is medium to large. Further, when the intake air flow rate is small, the movable member and the inner wall surface of the compressor cover abut against and closely contact each other, causing the movable member to be arranged so as to block the inner wall surface side of the intake air flow path. This makes it possible to make the flow path area of the intake air flow path small while reducing backflow of the intake air, which easily occurs at the tip side (shroud side) of the rotor blade of the impeller when the intake air flow rate is small. Thus, the effective flow path area of the intake air flow path can be adjusted smaller or larger according to the intake air flow rate, making it possible to improve efficiency in the small flow rate zone and widen the operation range.

### SUMMARY

However, in the above-described related-art throttling mechanisms provided with a movable member, when the flow rate is small, unless the movable member retracted toward the impeller of the centrifugal compressor and the inner wall surface of the compressor cover are in a perfect, close-fitting surface contact with each other over the entire circumference, there is a risk that the recirculation flow (backflow) of the intake air may leak through the gap between the movable member and the inner wall surface of the compressor cover, the desired effect of reducing the recirculation flow may not be obtained, and leakage loss may increase. That is, there are cases where it is difficult to favorably improve efficiency in the small flow rate zone and widen the operation range.

Further, in the above-described related-art throttling mechanisms, in order to bring the movable member and the inner wall surface of the compressor cover into a perfect, close-fitting contact with each other when the flow rate is small, extremely high processing accuracy and assembly accuracy are required in processing the movable member, the inner wall surface of the compressor cover, the movement mechanism, and the like, as well as in for example attaching and assembling the movable member and the movement mechanism. That is, unless the movable member, the compressor cover, and the like are processed and manufactured with extremely high processing accuracy and assembly accuracy, there are cases where it is difficult to improve efficiency in the small flow rate zone and widen the operation range. Thus, a large amount of labor, time, extra effort, and cost are required for the manufacture of throttling mechanisms as well as centrifugal compressors and turbochargers.

In light of the foregoing, an object of the disclosure is to provide a centrifugal compressor that is more efficient and effective, and that can more economically improve efficiency in the small flow rate zone and widen the operation range compared to the related art.

A centrifugal compressor according to an aspect of the disclosure includes an impeller; a compressor cover including at least an inlet pipe portion having an intake air flow path formed for sending gas to the impeller; a movable member disposed inside the compressor cover so as to be movable along a direction of an axis of the impeller; and a movement mechanism configured to move the movable member along a direction of the axis of the impeller, the movement mechanism moving the movable member along the direction of the axis to bring the movable member and an inner wall surface of the compressor cover into contact with each other, wherein at least one of the compressor cover or the movable member including a contact portion configured of an abradable sealing material or a high-elasticity plastic material, the contact portion being a portion at which the compressor cover and the movable member come into contact with each other.

According to the centrifugal compressor of an aspect of the disclosure, it is possible to provide a centrifugal compressor that is more efficient and effective, that can more economically improve efficiency in the small flow rate zone and widen the operation range, and that has superior operating performance, reliability, and durability compared to the related art.

### BRIEF DESCRIPTION OF DRAWINGS

The disclosure will be described with reference to the accompanying drawings, wherein like numbers reference like elements.

FIG. 1 is a diagram illustrating an example of a turbocharger provided with a centrifugal compressor according to an embodiment of the disclosure.

FIG. 2 is a partial cross-sectional view illustrating an example of the centrifugal compressor according to the embodiment of the disclosure.

FIG. 3A is a partial cross-sectional view illustrating an example of a movable member of the centrifugal compressor according to the embodiment of the disclosure.

FIG. 3B is a partial cross-sectional view illustrating an example of the movable member of the centrifugal compressor according to the embodiment of the disclosure.

FIG. 3C is a partial cross-sectional view illustrating an example of the movable member of the centrifugal compressor according to the embodiment of the disclosure.

FIG. 3D is a partial cross-sectional view illustrating an example of the movable member of the centrifugal compressor according to the embodiment of the disclosure.

FIG. 4 is a diagram showing an example of the performance of the centrifugal compressor according to the embodiment of the disclosure, the diagram showing the relationship between a flow rate and a pressure ratio of intake air.

FIG. 5 is a partial cross-sectional view illustrating a modified example of the centrifugal compressor according to the embodiment of the disclosure.

### DESCRIPTION OF EMBODIMENTS

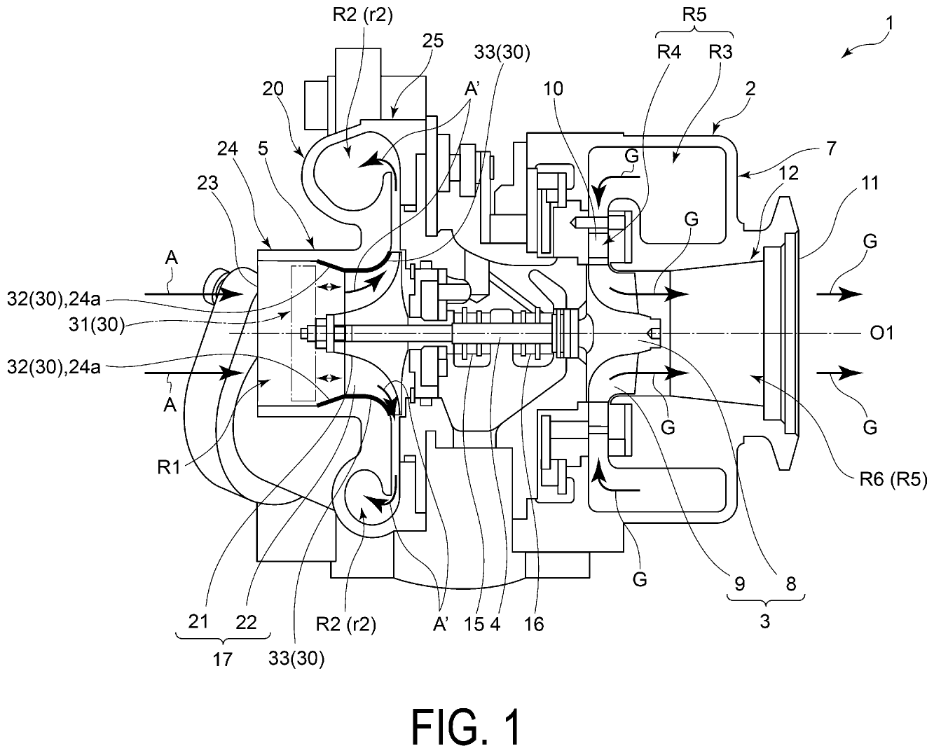

Hereinafter, a centrifugal compressor according to an embodiment will be described with reference to FIGS. 1 to 5.

Here, in the present embodiment, a centrifugal compressor of the disclosure is described as being installed in a turbocharger. However, the centrifugal compressor of the disclosure may be, for example, an electric centrifugal compressor. In addition, the gas to be compressed is not limited to air. That is, as long as it is capable of compressing and sending gas, the centrifugal compressor of the disclosure may be configured as a standalone centrifugal compressor, and may be combined with a mechanism or device other than a turbine. Further, its application and the like are not limited.

### Turbocharger

As illustrated in FIG. 1, for example, a turbocharger 1 of the present embodiment is configured such that the energy of exhaust gas G sent from an engine such as an automobile engine causes an impeller (turbine wheel) 3 of a turbine 2 to rotate about an axis (rotation axis) O1 and, along with this, causes a rotor shaft 4 coaxially connected to the impeller 3 as well as an impeller (compressor wheel) 17 of an centrifugal compressor (compressor) 5 coaxially connected to the rotor shaft 4 to rotate so as to cause the impeller 17 to take in and compress air (intake air, gas) A and supply the compressed air (compressed gas) A′ to the engine.

### Turbine

The turbine 2 includes the impeller 3 provided in coaxial connection to the other end of the rotor shaft 4, and a turbine cover (turbine housing) 7 for housing the impeller 3.

The impeller 3 includes a turbine hub 8 having a substantially truncated-conical shape and provided in coaxial connection to the rotor shaft 4, and a turbine rotor blade 9 extending radially outward of the center of the axis O1 from the outer circumferential surface of the turbine hub 8.

An exhaust gas flow path R5 is provided radially outward of the center of the axis O1 of the impeller 3 of the turbine 2. The exhaust gas flow path R5 includes a scroll flow path R3, provided on the periphery of the impeller 3, for feeding the exhaust gas G discharged from the engine to the impeller 3, and a nozzle flow path R4 provided with an exhaust gas flow rate adjustment device such as a nozzle vane 10.

Further, a discharge flow path R6 (exhaust gas flow path R5) is provided coaxially with the impeller 3, on the rear side of the impeller 3 in the direction of the axis O1 (on the discharge port 11 side of the exhaust gas G), for receiving the exhaust gas G emerging from the outlet of the turbine rotor blade 9 of the impeller 3 and discharging the gas outside. This discharge flow path R6 is constituted by an exhaust diffuser 12.

Further, in the turbocharger 1 of the present embodiment, the scroll flow path R3, the nozzle flow path R4, and the discharge flow path R6 (exhaust diffuser 12) are formed by the turbine cover 7 for housing the impeller 3.

### Centrifugal Compressor: Compressor

The centrifugal compressor 5 of the present embodiment includes the impeller (compressor wheel) 17 of the centrifugal compressor 5 provided in coaxial connection to one end of the rotor shaft 4 rotatably supported on bearing stands 15, 16, and a compressor cover 20 for housing the impeller 17.

The impeller 17 of the centrifugal compressor 5 includes a compressor hub 21 having a substantially truncated-conical shape and provided in coaxial connection to the rotor shaft 4, and a compressor rotor blade (impeller rotor blade) 22 extending radially outward of the center of the axis O1 from the outer circumferential surface of the compressor hub 21.

An intake air flow path R1 is provided on the front side of the impeller 17 in the direction of the axis O1 (on the suction port 23 side of the air A) for taking in the air A along with the rotation of the impeller 17 and feeding the air to the impeller 17.

Further, a compressed air flow path (compressed gas flow path) R2 is provided radially outward of the center of the axis O1 of the impeller 17. The compressed air flow path (compressed gas flow path) R2 includes a swirl chamber r2 for receiving the compressed air A′ emerging from the impeller 17 and feeding the air to the engine.

Further, in the turbocharger 1 of the present embodiment, the portion of the compressor cover 20 at which the intake air flow path R1 for taking in the air A and supplying the air to the impeller 17 is referred to as an inlet pipe portion (suction portion) 24, while the portion that forms the compressed air flow path R2 is referred to as a compressor cover main body portion 25. In the present embodiment, the inlet pipe portion 24 and the compressor cover main body portion 25 are formed from a metal (main raw material of the compressor cover 20) such as aluminum, for example. Note that, as described below, the inlet pipe portion 24 may be configured as a separate component, and the inlet pipe portion 24 and the compressor cover main body portion 25 may be formed from different materials.

In the turbocharger 1 of the present embodiment configured as described above, the exhaust gas G discharged from the engine is supplied from the radial outside of the impeller 3 of the turbine 2 via the scroll flow path R3 and the nozzle flow path R4 of the turbine 2. The energy of this exhaust gas G drives the impeller 3 to rotate. The rotation of this impeller 3 drives the rotor shaft 4 and the impeller 17 of the centrifugal compressor 5 to rotate.

Further, the rotation of the impeller 17 causes the air A to be taken in from the suction port 23 of the inlet pipe portion 24, flow through the intake air flow path R1, and be supplied to the impeller 17 to be compressed, and thus the compressed air A′ is supplied to the engine via the compressed air flow path R2. After driving the impeller 3 of the turbine 2 to rotate, the pressure of the exhaust gas G recovers as the exhaust gas G flows through the discharge flow path R6 of the exhaust diffuser 12 before being discharged outside.

On the other hand, the centrifugal compressor 5 (turbocharger 1) of the present embodiment includes a flow path area adjustment portion 30 configured to adjust an effective flow path area of the intake air flow path R1 of the inlet pipe portion 24, through which the air A is taken in and supplied to the impeller 17 by the rotation of the impeller 17, and thereby adjust the flow rate, pressure, and flow velocity of the air (intake air) A at the inlet of the impeller 17.

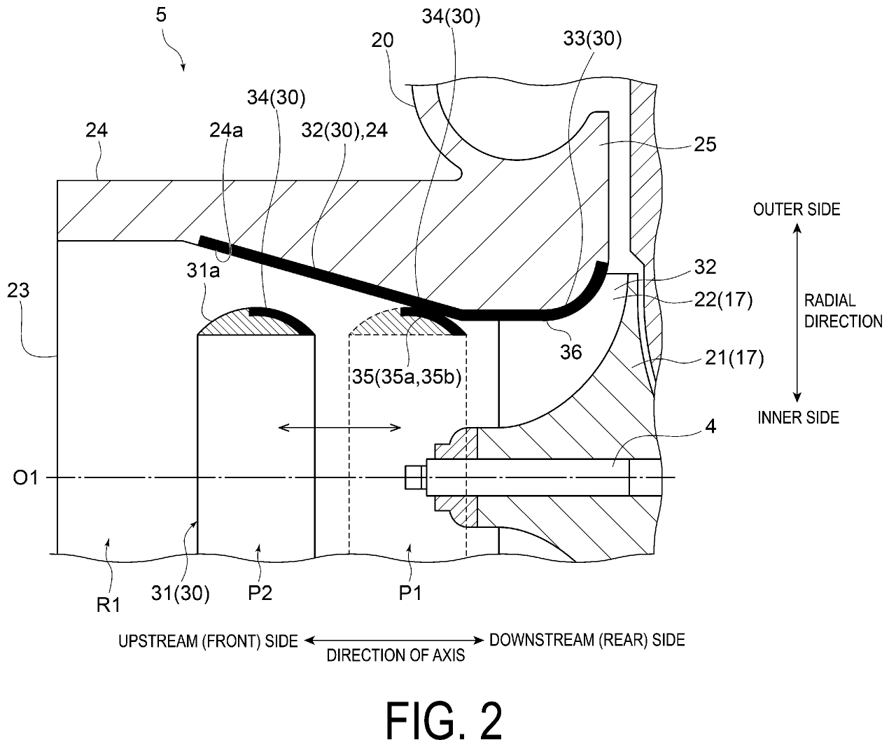

As illustrated in FIGS. 1 and 2, the flow path area adjustment portion 30 of the centrifugal compressor 5 of the present embodiment includes a movable member 31 disposed in the inside of the inlet pipe portion 24 that constitutes the inside of the compressor cover 20, and provided so as to be movable forward and rearward along the direction of the axis O1 of the impeller 17; and a movement mechanism (not illustrated) configured to move the movable member 31 along the direction of the axis O1.

The movable member 31 of the present embodiment is an annular member formed in a circular shape, and is provided in the intake air flow path

R1 inside the inlet pipe portion 24 such that the movable member 31 and the intake air flow path R1, as well as the inlet pipe portion 24, are coaxially disposed on the axis O1.

Further, this movable member 31 is provided such that, when the movement mechanism causes the movable member 31 to move rearward in the direction of the axis O1, the movable member 31 comes into contact with an inner wall surface 24a of the inlet pipe portion 24 upstream of the leading edge of the rotor blade 22 of the impeller 17.

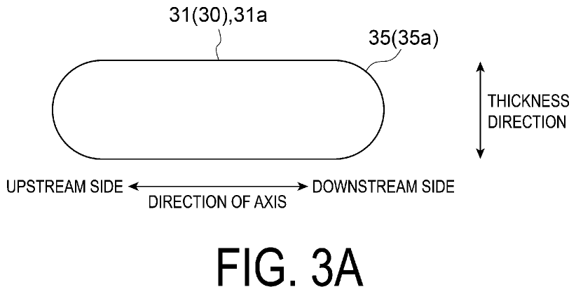

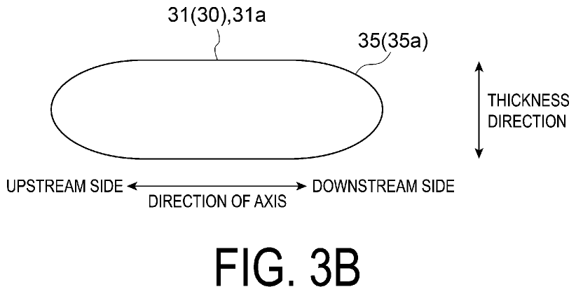

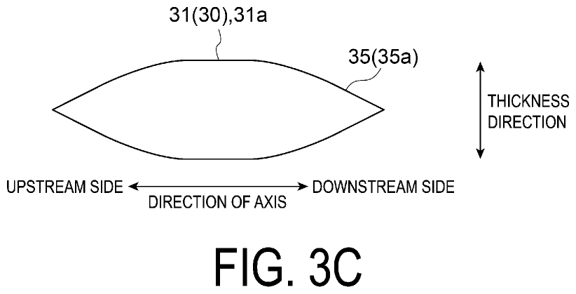

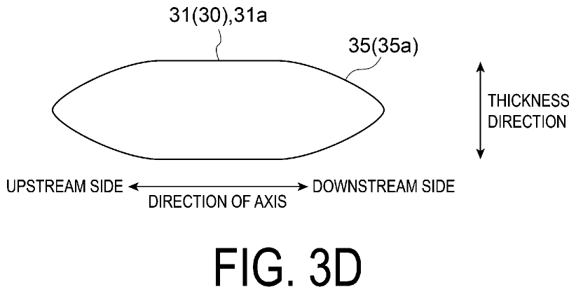

Here, the shape of the movable member 31 is not particularly limited. For example, as illustrated in FIGS. 2 and 3A to 3D, the cross-sectional shape of the movable member 31, the shapes of mutual contact portions 35 (35a, 35b) of the inner wall surface 24a of the compressor cover 20 and the movable member 31, the orientation with respect to the axis O1, and the like may be determined as appropriate.

For example, the movable member 31 may have an inner circumferential surface or an outer circumferential surface (the entire inner circumferential surface or the entire outer circumferential surface) inclined with respect to the axis O1; and the shape of the leading edge side and the trailing edge side may be different (may be asymmetrical in shape) with the center in the thickness direction of the movable member 31 along the axis O1 serving as boundary, examples of which include a wing shape.

Examples of the movable member 31 that can be favorably employed include the “annular portion” described in patent applications No.: PCT/JP2019/11539 and PCT/JP2019/11544, which have been invented and already filed by the inventors of the present application.

The movement mechanism includes, for example, a strut (not illustrated) for supporting the movable member (annular member) 31, and an actuator (not illustrated).

As illustrated in FIG. 2, this flow path area adjustment portion 30 is configured such that driving the actuator of the movement mechanism causes the strut to move forward and rearward in the direction of the axis O1, and thereby makes the movable member (annular member) 31 movable along the direction of the axis O1 between a first position P1 in the direction of the axis 01 of the intake air flow path R1 and a second position P2 upstream of the first position P1 in the direction of the axis O1. Further, when the movable member 31 is moved to the first position P1, the movable member 31 abuts against the inner wall surface 24a of the compressor cover 20 that forms the intake air flow path R1.

Further, in the present embodiment, the inner wall surface 24a of the compressor cover 20 that forms the inlet pipe portion 24 includes an inclined surface (tapered surface) 24b that is inclined such that the inner diameter of the inlet pipe portion 24 (the diameter of the intake air flow path R1) increases toward the front side in the direction of the axis O1, that is, toward the upstream side in the intake air flow direction, so as to minimize as much as possible an increase in the pressure loss of the intake air caused by the movable member 31 being arranged in the intake air flow path R1.

In the present embodiment, this inclined surface 24b is formed such that the diameter of the intake air flow path R1 gradually increases from the inlet side of the impeller 17 on the rear end side of the inlet pipe portion 24 toward the suction port 23.

When the movement mechanism causes the movable member 31 to retract to the first position P1, an outer circumferential surface 31a of the rear end side of the movable member 31 abuts against the inclined surface 24b to make the effective flow path area of the intake air flow path R1 small.

More specifically, the movable member (annular member) 31 of the present embodiment is formed such that the contact portion 35a of the outer circumferential surface 31a faces the inclined surface 24b ; when the movable member 31 is positioned at the second position P2, the contact portion 35a of the movable member 31 and the inclined surface 24b are separated; and as the movable member 31 is moved downstream from the second position P2 in the direction of the axis O1, the distance between the contact portion 35a of the movable member 31 and the inclined surface 24b decreases.

When the movable member 31 is retracted to the first position P1, the contact portion 35a of the outer circumferential surface 31a abuts against the inclined surface 24b, blocking an outer circumferential portion of the intake air flow path R1 corresponding to the tip portion of the impeller blade 22 (the radially outward end portion of the blade 22). Further, at this time, when viewed in the direction of the axis O1, the movable member 31 and the tip portion of the impeller blade 22 at least partially overlap.

As a result, when the movable member 31 is disposed at the first position P1, the outer circumferential portion corresponding to the tip portion of the impeller blade 22 is blocked by the movable member 31, diminishing the effective flow path area of the intake air flow path R1.

When the flow path area is diminished due to the retraction of the movable member 31 in this way, the peak efficiency decreases, but the surge flow rate is lowered and the efficiency in the vicinity of the surge point is improved.

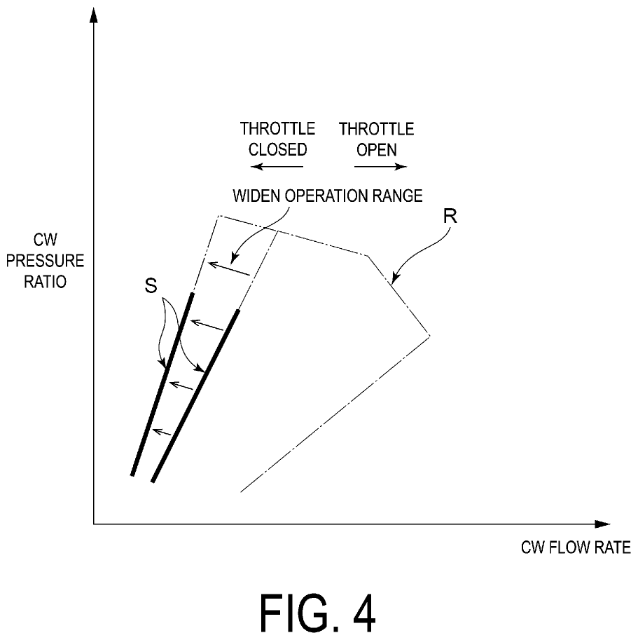

That is, at operating points on the small flow rate side (operating points in the vicinity of the surge point), the movable member 31 is positioned at the first position P1; while at operating points on the large flow rate side (for example, during rated operation) where the flow rate is larger than that of the above-described operating points on the small flow rate side, the movable member 31 is positioned at the second position P2, which allows the size of the effective flow path area to be adjusted according to the intake air flow rate. As a result, as shown in FIG. 4, it is possible to improve the efficiency of the operating points on the small flow rate side, and expand the movable range/operating range of the centrifugal compressor. That is, it is possible to improve efficiency in the small flow rate zone and widen the operation range.

Incidentally, the outer circumferential surface 31a of the movable member 31 of the present embodiment is formed into a convex arc shape, with the leading edge and the trailing edge being smoothly connected. This makes it possible, when the movable member 31 is at the second position P2, to reduce flow separation at the outer circumferential surface 31a of the movable member 31 and reduce a decrease in efficiency of the centrifugal compressor 5.

Here, in the flow path area adjustment portion (throttling mechanism) 30 provided with the movable member 31, when the flow rate is small, unless the movable member 31 retracted toward the impeller 17 and the inner wall surface 24a of the compressor cover 20 (contact portions 35a, 35b) are in a perfect, close-fitting contact with each other over the entire circumference, the recirculation flow (backflow) of the intake air leaks through the gap between the movable member 31 and the inner wall surface 24a of the compressor cover 20. When this leak occurs, the desired effect of reducing the recirculation flow is not obtained, and leakage loss increases, which consequently makes it impossible to favorably improve efficiency in the small flow rate zone and widen the operation range.

Further, in order to bring the movable member 31 and the inner wall surface 24a of the compressor cover 20 into a perfect, close-fitting contact with each other when the flow rate is small, extremely high processing accuracy and assembly accuracy are required in processing the movable member 31, the inner wall surface 24a of the compressor cover 20, the movement mechanism, and the like, as well as in for example attaching and assembling the movable member 31 and the movement mechanism. That is, unless the movable member 31, the compressor cover 20, and the like are processed and manufactured with extremely high processing accuracy and assembly accuracy, it is impossible to improve efficiency in the small flow rate zone and widen the operation range. Thus, a large amount of labor, time, extra effort, and cost are required for the manufacture of the flow path area adjustment portion (throttling mechanism) 30 as well as the centrifugal compressor 5 and the turbocharger 1.

Furthermore, in the turbocharger 1 of an automobile engine and the like, for example, the intake air flow rate fluctuates at an unpredictably high frequency due to accelerator operation and the like. For this reason, the movable member 31 also repeats advancing, retracting, and sliding movements forward and rearward in the direction of the axis O1 an unpredictably very large number of times.

When the movable member 31 advances and retracts (slides) an unpredictably large number of times, the movable member 31 comes into contact with and is pressed against the inner wall surface 24a of the compressor cover 20 each time the intake air flow rate becomes small. That is, the movable member 31 and the inner wall surface 24a of the compressor cover 20 collide with each other. Since this collision occurs repeatedly an unpredictably large number of times, there is a risk that wear may occur at the contact portion 35a of the outer circumferential surface 31a of the movable member 31, and the contact portion 35b of the inner wall surface 24a of the compressor cover 20 made of aluminum and the like, against which the movable member 31 comes to abut. When this wear occurs, a gap is formed to induce the recirculation flow to leak, making it impossible to favorably improve efficiency in the small flow rate zone and widen the operation range.

Further, there is also a risk that repeated collision of the movable member 31 an unpredictably large number of times may damage the movable member 31 and the like.

Furthermore, there is also a risk that abnormal clattering sound may occur each time the movable member 31 collides with the inner wall surface 24a of the compressor cover 20.

In contrast, in the centrifugal compressor 5 (and the turbocharger 1) of the present embodiment, at least one of the portions (35a, 35b) of the movable member 31 and the compressor cover 20 at which the movable member 31 and the compressor cover 20 come into contact with each other is configured using an abradable sealing material or a high-elasticity plastic material.

Here, the “abradable sealing material” in the disclosure is a material having an easy-to-cut property (machinability), and is a well-known material widely used to fill in gaps between components that rotate at high temperatures or at high speeds in cases where the clearance needs to be controlled to near zero.

Examples of the “abradable sealing material” include resin-based ones (e.g., single-type resin material-based ones, composite resin material-based ones using a plural types of resin, composite resin material-based ones into which a filler such as carbon is mixed), carbon-based ones, metal-based ones (e.g., soft light metal-based ones such as nickel-based ones, aluminum-based ones, copper-based ones, and the like).

Examples of related-art applications of the “abradable sealing material” (see FIG. 1) include a case in which the material is laminated on the inner wall surface of the cover (casing) 7 of the turbine 2 and the inner wall surface of the cover (casing) 20 of the centrifugal compressor (compressor) 5 by thermal spraying and the like so as to be interposed between the tip portion of the rotor blade 9 of the impeller 3 and the inner wall surface of the cover 7 and between the tip portion of the rotor blade 22 of the impeller 17 and the inner wall surface of the cover 20, respectively. In this case, rotation of the respective impellers 3 and 17 causes the sealing layers of the “abradable sealing material” having machinability to be cut by the tip portions of the rotor blades 9 and 22 such that any gap between the tip portion of the rotor blade 9 and the inner wall surface of the cover 7 and between the tip portion of the rotor blade 22 and the inner wall surface of the cover 20 is properly reduced to zero. This “abradable sealing material” achieves clearance control and fills in gaps, making it possible to improve the efficiency of the centrifugal compressor 5 and the turbine 2.

On the other hand, the “high-elasticity plastic material” in the disclosure refers to a material (member) that has elasticity and that has a lower yield stress at which transition to plastic deformation is made in a stress-strain relationship compared to metal materials such as aluminum, which are widely used in the related art as a raw material for forming the compressor cover 20 (such as the compressor cover main body portion 25). Furthermore, the “high-elasticity plastic material” in the disclosure is preferably a material (member) having a greater linear elastic modulus compared to metal materials such as aluminum that form the compressor cover main body portion 25 of the compressor cover 20 in the related art.

Examples of such a “high-elasticity plastic material” include resin-based ones (e.g., single-type resin material-based ones, composite resin material-based ones using a plural types of resin, composite resin material-based ones into which a filler such as carbon is mixed), carbon-based ones, metal-based ones (e.g., soft light metal-based ones such as nickel-based ones, aluminum-based ones, copper-based ones, and the like).

### Operational Effect of Centrifugal Compressor of the Disclosure

In the centrifugal compressor 5 (and the turbocharger 1) of the present embodiment, as illustrated in FIG. 2, at least one of the contact portions 35a, 35b of the movable member 31 and the compressor cover 20 at which the movable member 31 and the compressor cover 20 come into contact with each other is configured using such an abradable sealing material (32, 34) or a high-elasticity plastic material.

As a result, compared to the related art, when the intake air flow rate is small, it is possible to easily bring the movable member 31 that has retracted toward the impeller 17 and the inner wall surface 24a of the compressor cover 20 into perfect, close-fitting contact with each other over the entire circumference. That is, at least one of the contact portions 35a, 35b of the movable member 31 and the compressor cover 20 is formed from the abradable sealing material (32, 34) or the high-elasticity plastic material. Thus, when the movement mechanism causes the movable member 31 to abut against the inner wall surface 24a of the compressor cover 20, the at least one of the contact portions 35a, 35b formed from the abradable sealing material (32, 34) or the high-elasticity plastic material undergoes deformation (such as elastic deformation) and the like, making it possible to easily bring the mutual contact portions 35a, 35b of the movable member 31 and the compressor cover 20 into a perfect, close-fitting contact with each other over the entire circumference.

Furthermore, at this time, at least one of the contact portions 35a, 35b of the movable member 31 and the compressor cover 20 is formed from the abradable sealing material (32, 34) having machinability or the high-elasticity plastic material having elastoplasticity. Thus, when the intake air flow rate is small, there is no need to take wear into consideration in causing the movable member 31 to retract and abut against the compressor cover 20 by the movement mechanism. This makes it possible to cause the movable member 31 to abut such that a great pressing force is applied. As a result, it is possible to even more easily bring the mutual contact portions 35a, 35b of the movable member 31 and the compressor cover 20 into a perfect, close-fitting contact with each other over the entire circumference.

Further, even in cases where the relative positions of the mutual contact portions 35a, 35b of the movable member 31 and the inner wall surface 24a of the compressor cover 20 are slightly misaligned, because the mutual contact portions 35a, 35b are formed from the abradable sealing material (32, 34) or the high-elasticity plastic material, the movable member 31 is pressed against the inner wall surface 24a of the compressor cover 20, and the abradable sealing material (32, 34) or the high-elasticity plastic material absorbs the misalignment (play) of the relative positions therebetween. This makes it possible to easily bring the respective contact portions 35a, 35b of the movable member 31 and the compressor cover 20 into a close-fitting contact with each other.

As a result, unlike the related art, there is no need to require extremely high processing accuracy and assembly accuracy in processing the movement mechanism and the like, as well as in for example attaching and assembling the movable member 31 and the movement mechanism, which makes it possible to improve manufacturing productivity, cost reduction, and the like.

Furthermore, even in cases where the movable member 31 advances and retracts (slides) an unpredictably large number of times, because the mutual contact portions 35a, 35b of the movable member 31 and the inner wall surface 24a of the compressor cover 20 are formed from the abradable sealing material (32, 34) or the high-elasticity plastic material, the collision of the movable member 31 does not cause (is not likely to cause) the movable member 31 or the inner wall surface 24a of the compressor cover 20 to wear. Further, at this time, even in cases where the abradable sealing material (32, 34) or the high-elasticity plastic material of the mutual contact portions 35a, 35b undergoes deformation, it is possible to bring the contact portions 35a, 35b of the movable member 31 and the compressor cover 20 into a close-fitting contact with each other in a manner corresponding to the deformation.

Further, it is also possible to favorably reduce damage of the movable member 31 and the like due to the repeated collision of the movable member 31 for an unpredictably large number of times.

As a result, even in cases where the movable member 31 and the inner wall surface 24a of the compressor cover 20 repeatedly come into contact and collide with each other an unpredictably large number of times, a gap is not created to induce the recirculation flow to leak, making it possible to favorably improve efficiency in the small flow rate zone and widen the operation range.

Furthermore, because the mutual contact portion 35a, 35b of the movable member 31 and the inner wall surface 24a of the compressor cover 20 is formed from the abradable sealing material (32, 34) such as resins and soft light metals or the high-elasticity plastic material, it is also possible to prevent abnormal clattering sound from occurring each time the movable member 31 abuts against the inner wall surface 24a of the compressor cover 20.

Therefore, according to the centrifugal compressor 5 of the present embodiment, because at least one of the contact portions 35a, 35b of the movable member 31 and the compressor cover 20 at which the movable member 31 and the compressor cover 20 come into contact with each other is configured using the abradable sealing material (32, 34) or the high-elasticity plastic material, it is possible to effectively reduce the recirculation flow (backflow) of the intake air from leaking through a gap between the movable member 31 and the inner wall surface 24a of the compressor cover 20. Thus, compared to the related art, it is possible to achieve greater efficiency and effectiveness, more economically improve efficiency in the small flow rate zone, and widen the operation range.

Further, in the centrifugal compressor 5 of the present embodiment, the movable member 31 includes an annular member disposed in the intake air flow path R1 so as to be movable downstream in the direction of the axis O1, and the annular member of this movable member 31 is configured to come into contact with the inner wall surface 24a of the inlet pipe portion 24 upstream of the leading edge of the impeller blade 22 of the impeller 17.

Configured in this way, the movable member 31 can more reliably reduces the recirculation flow (backflow) of the intake air from occurring.

Here, configurations of the centrifugal compressor 5 of the present embodiment in which the above-described operational effect can be favorably achieved and which of the abradable sealing material and the high-elasticity plastic material is used will be described using the configurations (a) to (e) below as examples.

(a) As illustrated in FIG. 2, an inlet pipe portion-side sealing layer 32 is provided on at least the contact portion 35b of the inner wall surface 24a of the compressor cover 20 (the contact portion 35b of the inlet pipe portion 24 with the movable member (annular member) 31). The inlet pipe portion-side sealing layer 32 is deposited by for example applying a coating of the abradable sealing material.

(b) As illustrated in FIG. 2, an annular member-side sealing layer 34 is provided on at least the contact portion 35a of the movable member (annular member) 31 with the inner wall surface 24a of the inlet pipe portion 24. The annular member-side sealing layer 34 is deposited by for example applying a coating of the abradable sealing material.

As described in (a) and (b) above, in cases where at least either the inlet pipe portion-side sealing layer 32 made of the abradable sealing material is provided on the contact portion 35b of the inner wall surface 24a of the compressor cover 20 or the annular member-side sealing layer 34 made of the abradable sealing material is provided on the contact portion 35a of the movable member 31, it is possible to form the inlet pipe portion-side sealing layer 32 and/or the annular member-side sealing layer 34 by for example coating the contact portions 35a and/or 35b with the abradable sealing material.

That is, the operational effect of the centrifugal compressor of the present embodiment described above can be easily obtained.

(c) Furthermore, as illustrated in FIG. 2, in cases where the inlet pipe portion-side sealing layer 32 is formed from the abradable sealing material, a sealing layer 33 formed from the abradable sealing material may be formed from the contact portion 35b of the inner wall surface 24a of the compressor cover 20 to at least a portion of a shroud surface 36 including a surface facing the tip of the impeller blade 22.

In other words, the inlet pipe portion-side sealing layer 32 is formed such that the sealing layer 33 made of the abradable sealing material extends to the contact portion 35b of the inner wall surface 24a of the compressor cover 20, the sealing layer 33 being for properly reducing any gap between the tip portion of the rotor blade 22 of the impeller 17 of the centrifugal compressor 5 and the inner wall surface 24a of the compressor cover 20 to zero.

In this case, when a laminate is formed on the shroud surface 36 facing the tip portion of the rotor blade 22 by for example applying a coating of the abradable sealing material in order to improve the efficiency of the centrifugal compressor 5, it is also possible to form a laminate on the contact portion 35b of the inner wall surface 24a of the compressor cover 20 that comes into contact with the movable member 31 by for example applying a coating of the abradable sealing material.

As a result, it is possible to more easily form the inlet pipe portion-side sealing layer 32 to prevent the recirculation flow from occurring. This allows the gap between the shroud surface 36 and the rotor blade 22 to be filled with the sealing layer 33 of the abradable sealing material and also improves efficiency synergistically. That is, it is possible to easily enable the centrifugal compressor 5 to have excellent efficiency performance while maintaining manufacturing productivity.

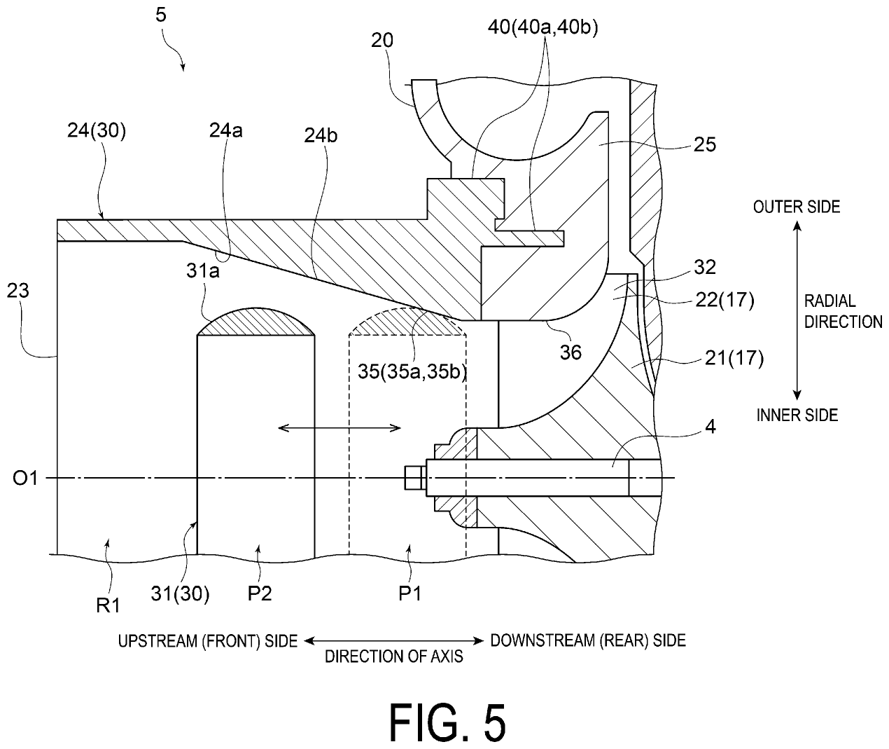

(d) Further, as illustrated in FIG. 5, the inlet pipe portion 24 is detachably attached to the compressor cover main body portion 25 to constitute the compressor cover 20, and this inlet pipe portion 24 is entirely formed from a high-elasticity plastic material (alternatively, the inlet pipe portion-side sealing layer 32 may be formed by for example applying a coating of the abradable sealing material on the contact portion 35b of the detachable inlet pipe portion 24 with the movable member 31).

In this case, it is desirable to provide a fitting portion 40 (protruding fitting portion 40a, recessed fitting portion 40b) on the rear end portion of the inlet pipe portion 24 and the front end portion of the compressor cover main body portion 25, respectively, such that the rear end portion of the inlet pipe portion 24 and the front end portion of the compressor cover main body portion 25 are fitted to each other and are positioned and held at predetermined relative positions. Further, it is also desirable to provide a flange portion on the rear end portion of the inlet pipe portion 24 and a plurality of screw holes passing through the flange portion, and provide a plurality of female screw holes at predetermined positions on the front end portion of the compressor cover main body portion 25, such that it is possible to firmly affix the inlet pipe portion 24 to the compressor cover main body portion 25 with screws.

When configured in this way, the operational effect of the centrifugal compressor 5 of the present embodiment can be achieved, and the inlet pipe portion 24 can also be replaced, making it possible to improve operability and maintainability.

(e) Further, the entire annular member of the movable member 31 is configured of the high-elasticity plastic material.

In this case as well, the operational effect of the centrifugal compressor 5 of the present embodiment can be achieved, and the movable member 31 can be easily replaced, making it possible to improve operability and maintainability.

(f) The configurations (a) to (e) described above may be selectively combined as appropriate.

Any of the configurations (a) to (e) described above can achieve the aforementioned effect (the operational effect of the centrifugal compressor of the disclosure).

While the embodiment of a centrifugal compressor according to the disclosure has been described above, the disclosure is not limited to the above-described embodiment, and modifications may be made as appropriate without deviating from the spirit and scope of the present invention.

For example, in the above description of the present embodiment, the movable member 31 is an annular member, and is provided in the intake air flow path R1 so as to be movable along the direction of the axis O1 to adjust the effective flow path area.

In contrast, in the centrifugal compressor of the disclosure, the movable member does not necessarily have to be an annular member, and the configuration of the movement mechanism for causing the movable member to move along the direction of the axis is not particularly limited as in the present embodiment.

Furthermore, in the centrifugal compressor of the disclosure, the movable member 31 does not necessarily have to be provided in the intake air flow path R1 that is formed as in the present embodiment. The shape, positioning (installation position) of the movable member 31 are not particularly limited as long as the movable member 31 is provided inside the compressor cover such that it is possible to achieve greater efficiency and effectiveness, more economically improve efficiency in the small flow rate zone, and widen the operation range compared to the related art.

For example, a bypass flow path in communication with the intake air flow path R1 may be provided inside the compressor cover 20 such that advancing and retracting movements of the movable member 31 forward and rearward in the direction of the axis O1 adjust the effective flow path area of this bypass flow path; and the contact portions 35a, 35b of the inner wall surface of the compressor cover 20 that form the bypass flow path and the movable member 31 may be configured using the abradable sealing material or the high-elasticity plastic material.

Finally, the contents of the embodiments described above can be understood as follows, for example.

(1) The centrifugal compressor (centrifugal compressor, compressor 5) according to an aspect includes an impeller (impeller 17); a compressor cover (compressor cover 20) including at least an inlet pipe portion (inlet pipe portion 24) having an intake air flow path (intake air flow path R1) formed for sending gas (air A) to the impeller; a movable member (movable member, annular member 31) disposed inside the compressor cover so as to be movable along a direction of an axis (direction of an axis O1) of the impeller; and a movement mechanism configured to move the movable member along the direction of the axis of the impeller, the movement mechanism moving the movable member in the direction of the axis to bring the movable member and an inner wall surface (inner wall surface 24a) of the compressor cover into contact with each other, wherein at least one of the compressor cover or the movable member including a contact portion (contact portion 35a, 35b) configured of an abradable sealing material or a high-elasticity plastic material, the contact portion being a portion at which the compressor cover and the movable member come into contact with each other.

According to the centrifugal compressor described in (1) above, at least one of the contact portions of the movable member and the compressor cover at which the movable member and the compressor cover come into contact with each other is configured using the abradable sealing material or the high-elasticity plastic material. Thus, compared to the related art, when the intake air flow rate is small, it is possible to easily bring the movable member evacuated toward the compressor wheel and the inner wall surface of the compressor cover into a perfect, close-fitting contact with each other.

That is, when the movement mechanism causes the movable member to abut against the inner wall surface of the compressor cover, the contact portion formed from the abradable sealing material or the high-elasticity plastic material undergo deformation (such as elastic deformation), making it possible to easily bring the mutual contact portions of the movable member and the compressor cover into a close-fitting surface contact with each other.

Furthermore, at this time, the at least one of the contact portions of the movable member and the compressor cover is formed from the abradable sealing material having machinability or the high-elasticity plastic material having elastoplasticity. Thus, when the intake air flow rate is small, the movement mechanism can cause the movable member to retract and abut against the compressor cover such that a greater pressing force than that of the related art is applied. As a result, it is possible to even more easily bring the mutual contact portions of the movable member and the compressor cover into a close-fitting surface contact with each other.

Further, even in cases where the relative positions of the mutual contact portions of the movable member and the inner wall surface of the compressor cover are slightly misaligned, because at least one of the mutual contact portions is formed from the abradable sealing material or the high-elasticity plastic material, the movable member is pressed against the inner wall surface of the compressor cover, which allows the misalignment (play) of the relative positions therebetween to be absorbed. Thus, it is possible to easily bring the mutual contact portions of the movable member and the compressor cover into a close-fitting surface contact with each other.

As a result, in order to bring the movable member and the inner wall surface of the compressor cover into a perfect, close-fitting contact with each other when the flow rate is small, unlike the related art, there is no need to require extremely high processing accuracy and assembly accuracy in processing the movement mechanism and the like, as well as in for example attaching and assembling the movable member and the movement mechanism, which makes it possible to improve manufacturing productivity, cost reduction, and the like.

Therefore, according to the centrifugal compressor described in (1) above, at least one of the contact portions of the movable member and the compressor cover at which the movable member and the compressor cover come into contact with each other is configured using the abradable sealing material or the high-elasticity plastic material. Thus, it is possible to effectively reduce the recirculation flow (backflow) of the intake air from leaking through a gap between the movable member and the inner wall surface of the compressor cover. Thus, compared to the related art, it is possible to achieve greater efficiency and effectiveness, more economically improve efficiency in the small flow rate zone, and widen the operation range.

(2) A centrifugal compressor according to another aspect is the centrifugal compressor described in (1) above, wherein the abradable sealing material is a resin-based material, a carbon-based material, or a metal-based material.

According to the centrifugal compressor described in (2) above, the operational effect described in (1) above can be favorably obtained.

(3) A centrifugal compressor according to another aspect is the centrifugal compressor described in (1) above, wherein the high-elasticity plastic material is a material that, in a state in which the contact portion is formed, has elasticity, and has a lower yield stress at which transition to plastic deformation is made in a stress-strain relationship compared to a compressor cover main body portion (compressor cover main body portion 25) formed from a main raw material of the compressor cover.

According to the centrifugal compressor described in (3) above, the operational effect described in (1) above can be favorably obtained.

(4) A centrifugal compressor according to another aspect is the centrifugal compressor described in (3) above, wherein the high-elasticity plastic material is a material that, in a state in which the contact portion is formed, has a greater linear elastic modulus compared to the compressor cover main body portion.

According to the centrifugal compressor described in (4) above, the operational effect described in (1) above can be more favorably obtained.

(5) A centrifugal compressor according to another aspect is the centrifugal compressor described in (2) or (3) above, wherein the high-elasticity plastic material is a resin-based material, a carbon-based material, or a metal-based material.

According to the centrifugal compressor described in (5) above, the operational effect described in (1) above can be more favorably obtained.

(6) A centrifugal compressor according to another aspect is the centrifugal compressor described in any one of (1) to (4) described above, wherein the movable member includes an annular member disposed in the intake air flow path so as to be movable downstream in the direction of the axis, the annular member being configured to come into contact with the inner wall surface of the inlet pipe portion upstream of the leading edge of the impeller blade (impeller blade, rotor blade 22) of the impeller.

According to the centrifugal compressor described in (6) above, at least one of the contact portions of the movable member and the compressor cover at which the movable member and the compressor cover come into contact with each other is configured using the abradable sealing material or the high-elasticity plastic material. Thus, when the intake air flow rate is small, it is possible to easily bring the annular member of the movable member evacuated toward the compressor wheel and the inner wall surface of the compressor cover into a perfect, close-fitting contact with each other over the entire circumference.

Thus, it is possible to effectively reduce the recirculation flow of the intake air from leaking through a gap between the annular member of the movable member and the inner wall surface of the compressor cover, which makes it possible to achieve greater efficiency and effectiveness, more economically improve efficiency in the small flow rate zone, and widen the operation range compared to the related art.

(7) A centrifugal compressor according to another aspect is the centrifugal compressor described in (6) above, wherein the inlet pipe portion is an inlet pipe portion-side sealing layer (inlet pipe portion-side sealing layer 32) deposited on the contact portion of the inlet pipe portion with the annular member, and is configured of the abradable sealing material.

According to the centrifugal compressor described in (7) above, the inlet pipe portion-side sealing layer is formed by for example applying a coating of the abradable sealing material on the contact portion of the inlet pipe portion, so that the operational effect described in (1), (6) above, and the like can be achieved.

In other words, the inlet pipe portion-side sealing layer is simply formed by for example coating the contact portion of the inlet pipe portion with the abradable sealing material, so that the operational effect described in (1), (6) above, and the like can be achieved.

(8) In a centrifugal compressor according to another aspect is the centrifugal compressor described in (7) above, wherein the compressor cover further includes a shroud surface (shroud surface 36) including a surface facing the tip of the impeller blade of the impeller, and the inlet pipe portion-side sealing layer is formed to extend from the contact portion to at least a portion of the shroud surface.

According to the centrifugal compressor described in (8) above, the inlet pipe portion-side sealing layer is formed such that the sealing layer made of the abradable sealing material extends to the contact portion of the inner wall surface of the compressor cover, the sealing layer being for properly reducing the gap between the tip of the impeller rotor blade and the inner wall surface of the compressor cover to zero.

In this case, in order to improve the efficiency of the compressor, it is possible to form a laminate on the shroud surface facing the tip of the impeller rotor blade by for example applying a coating of the abradable sealing material, and form a laminate on the contact portion of the inner wall surface of the compressor cover that comes into contact with the movable member by for example applying a coating of the abradable sealing material.

As a result, it is possible to more easily form the inlet pipe portion-side5 sealing layer to prevent the recirculation flow from occurring. This allows the gap between the shroud surface and the rotor blade to be filled with the sealing layer of the abradable sealing material, which makes it possible to obtain synergistical efficiency improvement effects. That is, it is possible to easily enable the centrifugal compressor to have excellent efficiency performance while maintaining manufacturing productivity.

(9) A centrifugal compressor according to another aspect is the centrifugal compressor described in (6) above, wherein the compressor cover includes a compressor cover main body portion (compressor cover main body portion 25) and an inlet pipe portion detachably attached to the compressor cover main body portion, the inlet pipe portion being entirely configured of the high-elasticity plastic material.

According to the centrifugal compressor described in (9) above, the inlet pipe portion can be separately manufactured using the high-elasticity plastic material. Thus, by merely attaching this inlet pipe portion to the compressor cover main body portion, the operational effect described in (1), (6) above, and the like can be easily obtained.

In addition to this, the inlet pipe portion entirely configured of the high-elasticity plastic material can be detached from the compressor cover main body portion and replaced. As a result, the operability, maintainability, and the like of the centrifugal compressor (inlet pipe portion) can be substantially improved.

(10) A centrifugal compressor according to another aspect is the centrifugal compressor described in any one of (6) to (9) above, wherein the annular member is an annular member-side sealing layer (annular member-side sealing layer 34) deposited on the contact portion of the annular member with the inner wall surface of the inlet pipe portion, and is configured of the abradable sealing material.

According to the centrifugal compressor described in (10) above, the annular member-side sealing layer is formed by for example applying a coating of the abradable sealing material on the contact portion of the annular member, which is the movable member, so that the operational effect described in (1), (6) to (9) above, and the like can be achieved.

In other words, the annular member-side sealing layer is simply formed by for example applying a coating of the abradable sealing material on the contact portion of the annular member, which is the movable member, so that the operational effect described in (1), (6) to (9) above, and the like can be achieved.

(11) A centrifugal compressor according to another aspect is the centrifugal compressor described in any one of (6) to (9) above, wherein the annular member is entirely configured of the high-elasticity plastic material.

According to the centrifugal compressor described in (11) above, the entire annular member, which is the movable member, can be separately manufactured using the high-elasticity plastic material, allowing the operational effect described in (1), (6) to (9) above, and the like to be easily obtained.

In addition to this, because the entire annular member, which is the movable member, is configured of the high-elasticity plastic material, ease of fabrication, maintainability such as replacement, and the like can be improved.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A centrifugal compressor, comprising:
an impeller;
a compressor cover including at least an inlet pipe portion including an intake air flow path formed for sending gas to the impeller;
a movable member disposed inside the compressor cover so as to be movable along a direction of an axis of the impeller; and
a movement mechanism configured to move the movable member along a direction of the axis of the impeller, the movement mechanism moving the movable member along the direction of the axis to bring the movable member and an inner wall surface of the compressor cover into contact with each other, wherein
at least one of the compressor cover or the movable member includes a contact portion configured of an abradable sealing material or a high-elasticity plastic material, the contact portion being a portion at which the compressor cover and the movable member come into contact with each other.

2. The centrifugal compressor according to claim 1, wherein
the abradable sealing material is a resin-based material, a carbon-based material, or a metal-based material.

3. The centrifugal compressor according to claim 1, wherein
the high-elasticity plastic material is a material that, in a state in which the contact portion is formed, has elasticity, and has a lower yield stress at which transition to plastic deformation is made in a stress-strain relationship compared to a compressor cover main body portion formed from a main raw material of the compressor cover.

4. The centrifugal compressor according to claim 3, wherein
the high-elasticity plastic material is a material that, in a state in which the contact portion is formed, has a greater linear elastic modulus compared to the compressor cover main body portion.

5. The centrifugal compressor according to claim 2, wherein
the high-elasticity plastic material is a resin-based material, a carbon-based material, or a metal-based material.

6. The centrifugal compressor according to claim 1, wherein
the movable member includes an annular member disposed in the intake air flow path so as to be movable downstream in the direction of the axis, the annular member being configured to come into contact with an inner wall surface of the inlet pipe portion upstream of a leading edge of an impeller blade of the impeller.

7. The centrifugal compressor according to claim 6, wherein
the inlet pipe portion is an inlet pipe portion-side sealing layer deposited on a contact portion of the inlet pipe portion with the annular member, the inlet pipe portion being configured of the abradable sealing material.

8. The centrifugal compressor according to claim 7, wherein
the compressor cover further includes a shroud surface including a surface facing a tip of the impeller blade of the impeller, and
the inlet pipe portion-side sealing layer is formed to extend from the contact portion to at least a portion of the shroud surface.

9. The centrifugal compressor according to claim 6, wherein
the compressor cover includes a compressor cover main body portion, and the inlet pipe portion detachably attached to the compressor cover main body portion, and
the inlet pipe portion is entirely configured of the high-elasticity plastic material.

10. The centrifugal compressor according to claim 6, wherein
the annular member is an annular member-side sealing layer deposited on a contact portion of the annular member with the inner wall surface of the inlet pipe portion, the annular member being configured of the abradable sealing material.

11. The centrifugal compressor according to claim 6, wherein
the annular member is entirely configured of the high-elasticity plastic material.
